(19) United States
(12) Patent Application Publication
(10) Pub. No.: US 2026/0355871 A1
(43) Pub. Date: Nov. 12, 2026

(54) Method and Manufacturing Installation for Producing Workpieces

(71) Applicants: Carl Zeiss AG, Oberkochen (DE); Carl Zeiss Digital Innovation GmbH, Dresden (DE)

(72) Inventors: Nils Haverkamp, Oberkochen (DE); Christian Hoerr, Oberkochen (DE); Franz-Georg Ulmer, Vogtareuth (DE); Sladjan Matic, Oberkochen (DE); Christian Wissmann, Oberkochen (DE); Daniel Goersch, Oberkochen (DE)

(21) Appl. No.: 19/714,253

(22) Filed: Jun. 19, 2026

Related U.S. Application Data
(63) Continuation of application No. PCT/EP2024/062955, filed on May 10, 2024.

(30) Foreign Application Priority Data
Dec. 19, 2023 (WO) PCT/EP2023/086557

(51) Int. Cl. B23P 15/00

(52) U.S. Cl. CPC B23P 15/00

(57) ABSTRACT

A method for producing multiple workpieces in a manufacturing installation uses a manufacturing machine, a movable machine element, a controller, and a metrology device. The method obtains nominal workpiece data that defines desired workpiece characteristics and acceptable tolerances, and obtains a control program associated with the nominal workpiece data. The control program includes control commands and numerical control parameters that determine kinematic behavior of the movable machine element during individual production runs. The workpieces are produced using the movable machine element, the controller, and the control program, and are inspected using the metrology device to obtain actual workpiece characteristics. Individual numerical control parameters are deliberately varied between individual production runs. The actual workpiece characteristics are associated with the individual numerical control parameters based on the corresponding production runs to establish a data set representing characteristic machine behavior. Further workpieces are produced based on the data set.

### CROSS-REFERENCE TO RELATED APPLICATIONS

This application is a continuation of PCT Application No. PCT/EP2024/062955 filed May 10, 2024, which claims priority to PCT Application No. PCT/EP2023/086557 filed Dec. 19, 2023. The entire disclosures of the above applications are incorporated by reference.

### FIELD

The present disclosure relates to a method of producing a plurality of workpieces using a manufacturing installation that comprises a manufacturing machine having a moveable machine element and comprises a machine controller configured to control the moveable machine element based on a control program. The invention further relates to a manufacturing installation for producing a plurality of workpieces using the method, and to a computer program that facilitates implementation of such a method in a manufacturing installation.

### BACKGROUND

In many branches of industry, intense efforts are made to increase production output and product quality. Production quality is often defined in terms of whether the produced workpieces comply with predefined workpiece specifications. Workpieces not complying with the predefined specifications either require re-working or will be discarded, both of which reduces production output and efficiency. In order to monitor production quality, it has become known to integrate one or more metrology devices into the manufacturing installation and sometimes even directly into the manufacturing machine. However, it is difficult to adjust a manufacturing process in real time if product quality decreases, because recording and evaluation of measurement results on workpieces during production or shortly after production requires time and the time delay may often be too large to be effectively used for closed-loop manufacturing control. Time-to-result in measurement processes is often significantly longer than production cycle times or period lengths of production process fluctuations.

Notwithstanding, quality control has been of utmost interest in industrial manufacturing processes for years in order to achieve both cost-efficient production and high product acceptance on the customer's side. There are many concepts and approaches for establishing quality control processes in the industrial manufacture of workpieces.

By way of example, U.S. Pat. No. 11,249,458 B2 discloses a control system including a controller that controls machining of a workpiece and including a photographing device that photographs an image of the workpiece under machining operation. The controller generates a three-dimensional model of the workpiece under machining operation based on the acquired image, compares the generated three-dimensional model and a three-dimensional model generated by a machining simulation with each other, and determines a presence or absence of a machining defect based on a result of the comparison. When the machining defect is present and re-machining is possible, a setting is modified depending on a cause of the machining defect and additional machining is executed based on the modified setting.

U.S. Pat. No. 11,049,236 B2 discloses a system and method for performing real-time quality inspection of objects. The system and method include a transport to move objects being inspected, allowing the inspection to be performed in-line. At least one optical acquisition unit captures optical images of the objects being inspected. The optical images are matched to CAD models of objects, and the matched CAD model is extracted. A laser with an illumination light beam has a wavelength in the violet or ultraviolet range and conducts scans of the objects, which are formed into three-dimensional point clouds. The point clouds are compared to the extracted CAD models for each object and the object is determined to be acceptable or defective based on the extent of deviation between the point cloud and the CAD model.

US 2021/0208568 A discloses a manufacturing system comprising: a communication module for receiving a three-dimensional model and control commands including manufacturing instructions for the manufacturing machine with respective reference values, tolerance values, and/or intervention tolerance values; a manufacturing module, wherein the model, the instructions, and the commands are used to manufacture an object; a calculating module using the three-dimensional model and the manufacturing instructions to calculate the control commands; and a measuring device having a communication module for receiving the three-dimensional model, a capture module using sensors to measure the manufactured object, captured for the reference values and/or the tolerance values and/or intervention tolerance values, and a checking module, wherein a divergence of the measured values from the applicable manufacturing reference values and an exceeding of the associated manufacturing tolerance values and/or the associated intervention tolerance values result in a control signal.

U.S. Pat. No. 9,383,742 B2 discloses a system and method for error compensation in positioning a complex-shaped gas turbine engine part during manufacturing thereof with a machine. Theoretical measurements for a plurality of control points on the part are first retrieved. Actual measurements for the control points are then acquired in a coordinate system of the machine. If an error between the actual and theoretical measurements is beyond a tolerance, a transformation matrix is computed. The transformation matrix represents a transformation to be applied to the coordinate system to adjust a pose thereof for compensating the error. The transformation matrix may be computed and applied to the coordinate system iteratively until the actual measurements are brought within tolerance. A machining program may then be generated for manufacturing the part accordingly.

EP 3 045 992 A1 discloses a method using a feedback loop for compensating errors occurring in a production process. The method comprises generating actual property data of at least one sample object produced in a production assembly according to a production model, performing a nominal-actual value comparison thereby generating deviation data, and automatically creating an adapted production model based on nominal property data and on the deviation data. The adapted production model is useable in an adapted production process for producing an adapted object in the production assembly, and differs from the nominal property data so that the errors occurring in the production process are at least partially compensated in the adapted production process.

U.S. Pat. No. 6,975,918 B2 discloses a production system for the series manufacture of products, comprising a processing device which, as a function of control commands, actuates a tool for processing one of the products, a measuring device for the automatic measuring of a geometric actual dimension at one of the processed products, a correcting device which is coupled to the processing device and to the measuring device and which compares the actual dimension with a preset target dimension which lies within a tolerance interval. The correcting device intervenes in a corrective manner in the control commands of the tool if the actual dimension lies outside an intervention interval which lies within the tolerance interval.

U.S. Pat. No. 11,036,203 B2 discloses a fabrication system for fabricating a three-dimensional object using processing circuitry. The processing circuitry estimates, according to a fabrication condition and fabrication data, a three-dimensional object to be fabricated according to the fabrication data and corrects the fabrication data according to an estimation result of the three-dimensional object estimated by the processing circuitry.

U.S. Pat. No. 8,090,557 B2 discloses a method for operating an industrial processing machine, a production machine or a manipulation robot. At least part of the operation of the industrial machine is simulated with the aid of a simulation model and the simulated results and real-time data from the operation of the industrial machine are stored. The simulation can be carried out in the industrial machine and if this is the case a parametric representation of the simulation model can be at least partly produced using a unit for this purpose. To produce the parametric representation, a data-systems connection can be created between the industrial machine and the unit, by means of an Intranet and/or an Internet connection. In addition, the simulation can be carried out in an external simulation unit, the latter having a data-systems connection to the industrial machine by means of an Intranet and/or an Internet connection.

WO 2018/204410 discloses a system comprising a first data link to a manufacturing system configured to create a run of parts based on a common engineering schematic, comprising a second data link to a metrology device configured to measure at least some parts in the run of parts to generate measurement data representing a physical shape of each part of the at least some parts, and comprising a machine learning system including one or more processors in communication with a computer-readable memory storing executable instructions, wherein the one or more processors are programmed by the executable instructions to at least: access a neural network trained, based on measurement data of past parts in the run of parts, to make a prediction about a future part in the run of parts; forward pass the measurement data through the neural network to generate the prediction about the future part in the run; and determine whether to output instructions for adjusting operations of the manufacturing system based on the prediction.

U.S. Pat. No. 10,180,667 B2 discloses a measurement technique integrated into a manufacturing machine in which the measurement results are interpreted by a trained artificial intelligence (AI). The AI determines new nominal control data based on the measurement results.

Some prior art approaches aim to make corrections even before a workpiece is actually produced. In other words, they try to implement some sort of forward error correction using knowledge gained from a previously produced workpiece in the production process of a subsequently produced workpiece. Such preemptive error correction appears very promising in order to optimize the efficiency and the output of a real, non-ideal manufacturing installation. Unfortunately, industrial manufacturing processes and installations can be very complex and it is often difficult to clearly identify all the causes and effects that can lead to undesired production errors and product deficiencies. It is therefore common practice to operate a real manufacturing installation with process parameters that are carefully selected in such a manner that desired product characteristics are likely met even if the actual production run is affected in an unexpected manner. In other words, it is accepted best practice to not push a manufacturing installation to its limits if high product quality is a major goal.

Preemptive error correction becomes even more difficult if the number of workpieces to be produced, i.e. the batch size, is small. It is particularly difficult to estimate the causes and effects leading to production errors if only a small number of samples are available. On the other hand, it is more and more desirable to produce workpieces in small batch sizes (up to a batch size of one) in order to enable customer specific variations.

In a more general field of endeavor, namely what is called systems theory, a behavioral approach is discussed. By way of example, a publication titled “Behavioral systems theory in data-driven analysis, signal processing, and control” by Ivan Markovsky and Florian Dörfler, published in Annual Reviews in Control, Vol. 52, 2021, explain such behavioral approach. In an example, an autonomous walking excavator based on the approach is described. In another publication titled “Bridging direct & indirect data-driven control formulations via regularizations and relaxations” by Florian Dörfler, Jeremy Coulson, and Ivan Markovsky, published in IEEE Transactions on Automatic Control, vol. 68, 2023, the authors discuss connections between sequential system identification and control for linear time-invariant systems, often termed indirect data-driven control, as well as a contemporary direct data-driven control approach seeking an optimal decision compatible with recorded data assembled in a Hankel matrix and robustified through suitable regularizations. Another publication titled “Data-driven model predictive control: closed-loop guarantees and experimental results” by Julian Berberich, Johannes Köhler, Matthias A. Müller, Frank Allgöwer, published in at-Automatisierungstechnik, vol. 69, 2021, provides a comprehensive review and describes a practical implementation of a model predictive control (MPC) framework using only measured data and no explicit model knowledge.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

In view of the above, it is an object of the present invention to provide an improved manufacturing method and installation for efficiently producing workpieces with high product quality.

It is a further object to provide a method and installation that allow an efficient production of workpieces both in large and small batch sizes.

It is yet another object to provide a manufacturing method and installation that efficiently exploit knowledge gained during previous production runs in order to achieve high product quality.

According to an aspect, there is provided a method of producing a plurality of workpieces comprising the steps of
providing a manufacturing installation that comprises a manufacturing machine having a moveable machine element, a machine controller configured to control the moveable machine element based on a control program, and a metrology device configured to record a plurality of measurement values on a produced workpiece in order to determine respective workpiece characteristics of the produced workpiece,
obtaining nominal workpiece data defining respectively desired workpiece characteristics for the plurality of workpieces and defining acceptable tolerances for the respectively desired workpiece characteristics,
obtaining a control program in association with the nominal workpiece data,
producing the plurality of workpieces using the moveable machine element, the machine controller and the control program in a plurality of individual production runs, and
inspecting the plurality of workpieces using the metrology device in order to obtain respective actual workpiece characteristics for the plurality of workpieces,
wherein the control program comprises a plurality of control commands and a plurality of numerical control parameters associated with the nominal workpiece data, wherein the numerical control parameters determine a respective kinematic behavior of the moveable machine element during a respective individual production run, wherein individual numerical control parameters from the plurality of numerical control parameters are deliberately varied from one individual production run to another individual production run, and wherein the respective actual workpiece characteristics are associated with the individual numerical control parameters based on the individual production runs, thereby establishing a data set representing characteristic machine behavior, and wherein at least one further workpiece is produced based on the data set.

According to another aspect, there is provided a manufacturing installation for producing a plurality of workpieces comprising a manufacturing machine having a moveable machine element, a machine controller configured to control the moveable machine element based on a control program, and a metrology device configured to record a plurality of measurement values on a produced workpiece in order to determine workpiece characteristics of the produced workpiece, wherein the machine controller comprises at least one processor configured to obtain nominal workpiece data defining respectively desired workpiece characteristics for the plurality of workpieces and defining acceptable tolerances for the respectively desired workpiece characteristics, configured to obtain a control program in association with the nominal workpiece data, configured to produce the plurality of workpieces using the moveable machine element, the machine controller and the control program in a plurality of individual production runs, and configured to inspect the plurality of workpieces using the metrology device in order to obtain respective actual workpiece characteristics for the plurality of workpieces, wherein the control program comprises a plurality of control commands and a plurality of numerical control parameters associated with the nominal workpiece data, wherein the numerical control parameters determine a respective kinematic behavior of the moveable machine element during a respective individual production run, wherein the at least one processor is further configured to deliberately vary individual numerical control parameters from the plurality of numerical control parameters from one individual production run to another individual production run, and wherein the at least one processor is further configured to associate the respective actual workpiece characteristics with the individual numerical control parameters based on the individual production runs, thereby establishing a data set representing characteristic machine behavior.

There is also provided a computer program comprising program code configured to carry out the following method steps, when the program code is executed on at least one processor of a manufacturing installation that comprises a moveable machine element and a metrology device:
obtaining nominal workpiece data defining respectively desired workpiece characteristics for a plurality of workpieces and defining acceptable tolerances for the respectively desired workpiece characteristics,
obtaining a control program in association with the nominal workpiece data,
producing the plurality of workpieces using the moveable machine element in a plurality of individual production runs, and
inspecting the plurality of workpieces using the metrology device in order to obtain respective actual workpiece characteristics for the plurality of workpieces,
wherein the control program comprises a plurality of control commands and a plurality of numerical control parameters associated with the nominal workpiece data, wherein the numerical control parameters determine a respective kinematic behavior of the moveable machine element during a respective individual production run, wherein individual numerical control parameters from the plurality of numerical control parameters are deliberately varied from one individual production run to another individual production run, and wherein the respective actual workpiece characteristics are associated with the individual numerical control parameters based on the individual production runs, thereby establishing a data set representing characteristic machine behavior, wherein the data set is stored in a non-transient manner.

The new method and manufacturing installation thus enable manufacture of a plurality of workpieces having workpiece characteristics that correspond to desired characteristics and comply within acceptable tolerances respectively defined. By way of example, the desired workpiece characteristics may relate to at least one of dimensions such as length, width, height, distance, radius, diameter and/or size dimensions of one or more workpiece features; surface characteristics such as surface roughness, surface hardness and/or surface waviness; optical characteristics such as transparency, reflectivity and/or absorption characteristics; elasticity, flexibility and/or viscosity; density; electrical characteristics such as conductivity, capacitance, inductivity. Acceptable tolerances are preferably defined as tolerance intervals specified with respect to one or more nominal values for one or more of the afore-mentioned characteristics.

The new method and manufacturing installation deliberately introduce changes in the set of numerical control parameters respectively used for the production of the workpieces. By way of example, a first workpiece and a second workpiece from the plurality of workpieces are advantageously manufactured with two different sets of numerical control parameters although the first and second workpieces could likewise have been manufactured with the same sets of numerical control parameters. In other words, the differences in the two sets of numerical control parameters are neither necessitated by any differences in the desired workpiece characteristics for the first and second workpiece, such as different workpiece types and/or different workpiece sizes, nor required to maintain the first or second workpiece within the acceptable tolerances. Briefly, while the first and second workpieces would have been manufactured with the same set of numerical control parameters in a conventional manufacturing method, deliberate changes in the set of numerical control parameters are made from one production run to the other. In other words, deliberate manufacturing variance is established over a plurality of production runs that could have been carried out without such variance, especially with identical sets of numerical control parameters.

The two production runs for producing the first and second workpieces may advantageously be carried out one after the other such that the two different sets of numerical control parameters are used at different instances of time. In other example embodiments, the two production runs for producing the first and second workpieces may be carried out simultaneously, provided that the manufacturing machine allows simultaneous production of a plurality of workpieces with the moveable element. It is even conceivable that the first and second workpieces differ with respect to their respectively desired workpiece characteristics, such as different types or sizes. Different desired workpiece characteristics usually require different sets of numerical control parameters and maybe even different control instructions. Notwithstanding, the respective sets of numerical control parameters may additionally be varied compared to respective nominal numerical control parameters used for other specimens of the respective workpieces.

Preferably, the individual numerical control parameters are varied from one individual production run to another individual production run based on the acceptable tolerances. In other words, the deliberate changes are made based on the acceptable tolerances for the respectively desired workpiece characteristics, i.e. by taking into account the acceptable tolerances in such a manner that changes in the workpiece characteristics expectedly resulting from the changes in the numerical control parameters do not exceed threshold limits of the acceptable tolerances. Accordingly, the deliberate variation of the numerical control parameters and the resulting deliberate changes among the workpieces produced are small enough for keeping the workpiece characteristics of the produced workpieces within the acceptable tolerances. By way of example, an expectation value for the expected changes in the workpiece characteristics may be determined and used to determine an acceptable percentage or acceptable variation interval for a selected numerical parameter that is deliberately changed. The deliberate changes of one or more numerical control parameters may be made in a such manner that the workpiece produced complies with the desired workpiece characteristics with a likelihood of more than 90%, preferably a likelihood of more than 95%, and even more preferred a likelihood of more than 99%. An expectation value and/or likelihood may be determined based on production data from historical production runs using the manufacturing installation. Alternatively or additionally, an expectation value and/or likelihood may be determined in a try-and-error approach starting with minimal deliberate changes of one or more selected numerical control parameters and subsequently increasing the amount of the deliberate changes and/or the number of numerical control parameters selected for deliberate changes. In some example embodiments, selected numerical control parameters may be deliberately varied from one production run to another production run on a feature basis, in particular for one respective workpiece feature at a time.

The deliberate variation of one or more numerical control parameters from one production run to another allows to explore system behavior of the manufacturing installation in a very efficient manner. As a result, a digital twin or digital model of the manufacturing installation and process can be determined with high accuracy and reliability. Advantageously, the variation data can be collected during series production of a plurality of workpieces that are produced for purposes other than just optimizing the manufacturing process. This allows to gather and associate huge amounts of variation data in a very cost-effective manner. Based on the data set representing the characteristic machine behavior, the manufacturing process using the manufacturing installation can be modelled more accurately. This allows to optimize any subsequent manufacturing process in advance, which in turn further increases efficiency and output.

The afore-mentioned advantages are particularly important for the production of workpieces in small batch sizes. Moreover, the manufacturing installation can be pushed to its limits even if high product quality is a major goal. The above-mentioned objects are therefore completely achieved.

In a refinement, the individual numerical control parameters used during the respective production run form a set of individual numerical control parameters, and the individual numerical control parameters are deliberately varied in such a manner that different sets of individual numerical control parameters are used from one individual production run to another individual production run.

With this refinement, the plurality of workpieces each are produced with an individual set of numerical control parameters. The individual sets of numerical control parameters differ from one another with respect to at least one parameter. Even if the plurality of workpieces are individual specimens of a particular workpiece type, i.e. are of the same type and size, each individual workpiece is produced with a unique set of numerical control parameters. The refinement allows to gather huge amounts of data for the data set very quickly.

In another refinement, at least two workpieces from the plurality of workpieces are produced with a same set of numerical control parameters, while at least two other workpieces from the plurality of workpieces are produced with different sets of numerical control parameters, wherein the at least two workpieces produced with the same set of numerical control parameters and the at least two workpieces produced with different sets of numerical control parameters are all of the same type and size.

This refinement allows to detect process variations in the manufacturing installation more easily. Variations in the actual workpiece characteristics of the plurality of workpieces can be associated with the cause of the variations more reliably. As a result, this refinement facilitates detailed modelling of the manufacturing installation and production process.

In a further refinement, the individual numerical control parameters are systematically varied within predefined variation limits. Preferably, the individual numerical control parameters are randomly varied within predefined variation limits.

The predefined variation limits may be determined based on expectation values and/or a likelihood that the acceptable tolerances for the respectively desired workpiece characteristics are met. Randomly changing one or more numerical control parameters over the course of the production runs is a very efficient manner to collect data that represent the actual system behavior.

In a further refinement, each workpiece from the plurality of workpieces has a defined number of workpiece features, and the individual numerical control parameters are varied with respect to a selected workpiece feature from the defined number of workpiece features at a time.

In this refinement, numerical control parameters are deliberately changed on a feature by feature basis over the course of the production runs. This facilitates analysis and association of cause and effect and advantageously improves reliable system modeling.

In a further refinement, the method further comprises the steps of obtaining further nominal workpiece data defining further desired workpiece characteristics for a further workpiece, obtaining a further control program in association with the further nominal workpiece data, and producing the further workpiece using the moveable machine element, the machine controller and the further control program, wherein the further control program is obtained based on the further nominal workpiece data and based on the data set representing the characteristic machine behavior.

This refinement makes beneficial use of the data collected during the production of the plurality of workpieces. The further control program is obtained based on the data set and can thus be optimized with respect to the actual machine behavior. As a result, the further workpiece can be manufactured more efficiently with high quality, even if the further workpiece is manufactured in a small batch size. Based on the data set, numerical control parameters used in the further control program can advantageously be selected in a manner to prevent production errors to occur. Accordingly, the refinement facilitates forward error correction in the production process of the further workpiece.

In a further refinement, the further desired workpiece characteristics for the further workpiece differ from the desired workpiece characteristics for the plurality of workpieces.

This refinement makes beneficial use of the data collected during the production of the plurality of workpieces even in the case that the further workpiece is of a different type compared to the plurality of workpieces. Since the data set represents the actual machine behavior in real production situations, the data set allows to model the machine behavior with high predictability. Therefore, an optimum set of control parameters for the production process of the further workpiece can easier be determined.

In a further refinement, the data set is established to comprise a plurality of data pairs (uₖ, yₖ), with each data pair (uₖ, yₖ) of the plurality of data pairs comprising the individual numerical control parameters (uₖ) used during a respective individual production run from the plurality of individual production runs and comprising measurement values (yₖ) representing the respective actual workpiece characteristics resulting therefrom, with the plurality of data pairs representing a temporal sequence (w_{d}) of the plurality of individual production runs.

In this refinement, the data set represents a history of actual production runs under real production conditions. This allows to determine an appropriate set of control parameters for the production of any further workpieces in a very efficient manner. The temporal sequence provides additional information about the development of actual production runs and control parameters and thereby facilitates predictions about further production runs. Advantageously, extrapolation techniques can be used to determine an optimum set of control parameters for a subsequent production run.

In a further refinement, a reference sequence (wᵣ) of data pairs is defined based on the nominal numerical control parameters and based on nominal measurement values corresponding to the further nominal workpiece data, wherein modified numerical control parameters are determined using the reference sequence (wᵣ) of data pairs, and wherein the further workpiece is produced using the modified numerical control parameters instead of the nominal numerical control parameters.

This refinement provides an easy and efficient approach for determining optimized control parameters for a production run based on the desired workpiece characteristics of the workpiece to be produced.

In a further refinement, the plurality of workpieces each are workpieces of a same type.

Producing a plurality of workpieces of the same type and, preferably, also of the same size, is very efficient in terms of production costs and output. In addition, it facilitates modelling the behavior of the manufacturing installation in accordance with the new method and installation. The data set provides the cause-and-effect relationship between the plurality of numerical control parameters and the resulting workpiece characteristics in a straight-forward manner over a plurality of comparable production runs.

In a further refinement, the plurality of workpieces comprise workpieces of different types.

This refinement advantageously increases the extent of the parameter exploration. Varying not only the numerical control parameters over the course of actual production runs, but also the desired workpiece characteristics as a result of producing workpieces of different types broadens the scope of the variations and thus provides even broader insight into the actual behavior of the manufacturing installation. Based on the broader insight, numerical control parameters optimized for a broad range different workpiece characteristics can even better be determined.

In a further refinement, a complex device is assembled using at least one workpiece from the plurality of workpieces.

This refinement makes beneficial use of the workpiece produced under the new method and contributes to efficient and sustainable handling of materials and resources.

In a further refinement, the plurality of workpieces are packed for shipment.

This refinement facilitates actual use of the produced workpieces at locations remote from the manufacturing installation. It also helps to prevent damages or degradation of the workpieces on their way to further processing and/or actual use.

In a further refinement, the plurality of workpieces are shipped to at least one of a distributor or a number of customers.

This refinement makes clear that the plurality of workpieces produced are workpieces intended to be brought to the market for various purposes beyond optimization of the manufacturing processes using the manufacturing installation. The beneficial effects of the new method and manufacturing installation become especially visible.

It goes without saying that the aforementioned features and those yet to be explained below can be used not only in the combination specified in each case but also in other combinations or on their own, without departing from the scope of the present invention.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 shows a schematic illustration of an example embodiment of the manufacturing installation,

FIG. 2 shows a flowchart illustrating an example embodiment of a method for producing a plurality of workpieces, and

FIG. 3 shows a flowchart illustrating a further aspect of the new method in accordance with some example embodiments.

In the drawings, reference numbers may be reused to identify similar and/or identical elements.

### DETAILED DESCRIPTION

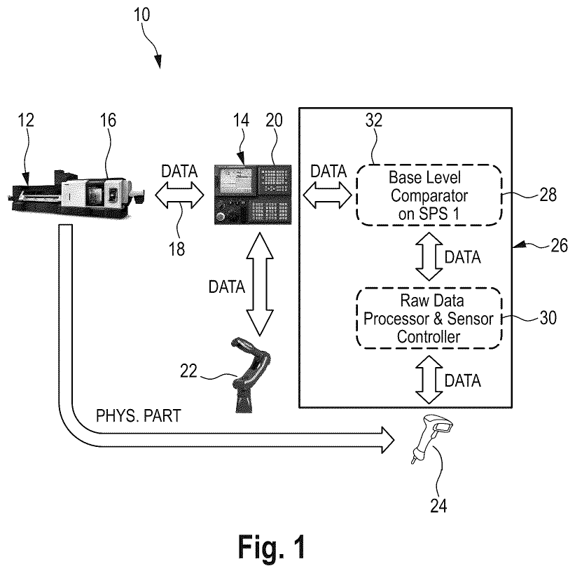

FIG. 1 shows an example embodiment of the new manufacturing installation 10 in a schematic illustration. Manufacturing installation 10 comprises a manufacturing machine 12 that is controlled by an associated machine controller 14. Manufacturing machine 12 is shown here as a multi-axis machine tool that is capable of at least one of cutting, milling, drilling, turning and/or grinding a workpiece. Suitable machine tools are commercially available of a plurality of vendors such as DMG Mori Seiki, Chiron, Heller and many others. Additionally or alternatively, manufacturing machine 12 may be a machine that is capable of welding, bending, pressing, additively and/or chemically manufacturing a workpiece. Without limitation, any type and brand of a controller controlled manufacturing machine that is capable of producing a workpiece from a raw material based on a CAD data set could be used here. All these manufacturing machines have at least one moveable machine element 16 controlled by machine controller 14, as is readily known to those skilled in the art. The at least one moveable machine element 16 may be a tool head that carries a cutting tool, milling tool, drilling tool, turning tool, grinding tool, welding tool, bending tool, pressing tool and/or a laser processing tool. Moreover, the moveable machine element 16 may be or may comprise an operating valve in a manufacturing installation that processes fluids and controls chemical reactions via a moveable machine element in the valve, for instance.

Manufacturing machine 12 and machine controller 14 exchange control data 18. The control data include, in particular, control commands and numerical control parameters, as it is known to those skilled in the art. By way of example, the control program may conform to what is known G-code or M-code and a numerical control parameter may define the rotational speed of a tool head or a distance of travel of the tool head or a valve stem, while the control command may activate a motor driving the moveable machine element.

The control commands are typically determined based on a data set defining desired workpiece characteristics, such as a CAD data set indicated at reference numeral 20 in FIG. 1. A workpiece (PHYS. PART; not shown here in more detail) is produced during a production run using the control data 18 in a manner known per se to those skilled in the art.

When the production run is finished, the workpiece is removed from the manufacturing machine 12, preferably by an automated handling system 22, such as a robot, and conveyed for further processing, such as being packed and/or stacked on pallets. Preferably, automated removal is synchronized with manufacturing machine controller 14. In some example embodiments, controller 14 may therefore exchange further control data with handling system 22 or even control handling system 22.

In example embodiments, handling system 22 automatically transfers the workpiece produced in the production run to a metrology device 24. Metrology device 24 may be a coordinate measuring machine (CMM) using a contact-type and/or non-contact-type probe, a computed tomography device, an industrial microscope, a hand-held optical scanning device and/or any other metrology device suitable and configured for inspecting the workpiece with respect to its workpiece characteristics. Optical metrology with cameras and/or laser scanners is particularly attractive in the field of machining, additive manufacturing (3D printing) and other forming processes. However, measurement technology and inspection are not limited to dimensional measurement technologies. Other defect detection methods are also conceivable, such as deflectometry, eddy current analysis, surface roughness profilometers, acoustic measurements, etc.

Metrology device 24 is preferably located in the vicinity of manufacturing machine 12 and preferably configured to automatically inspect the workpiece using a predefined inspection plan. In some example embodiments, metrology device 24 may be configured to automatically measure 3D point cloud data of measurement points recorded on the workpiece in order to determine dimensional and/or geometrical characteristics of the workpiece in accordance with the predefined inspection plan. The inspection plan may also be determined based on the CAD data set 18. In other example embodiments, metrology device 24 may be a probing head integrated into manufacturing machine 12, or a probing head that can selectively be introduced into manufacturing machine 12, in order to record measurement values on the workpiece while it is still fixed in the manufacturing machine 12. In yet another example embodiment, metrology device 24 may be a hand-held device, such as a hand-held 3D laser scanner.

In any case, metrology device 24 is a physical inspection device capable of and configured for recording measurement/inspection values on the workpiece, which measurement/inspection values represent actual workpiece characteristics. Preferably, automated test sequences and algorithmic interpretation of the results are implemented, such as DIN-ISO-compliant point cloud evaluation, CAD rule geometry comparisons, form and position evaluations, etc. In some preferred example embodiments, software tools commercially available from Carl Zeiss Industrielle Messtechnik GmbH, Germany, are used, such as the software tools Calypso (for regular geometries), Caligo (for free-form surfaces), Gear Pro (especially for measuring gears), GOM Inspect and/or GOM Volume Inspect.

In FIG. 1, manufacturing installation 10 further comprises a correction controller 26 that is configured to carry out correction steps explained further down below. In preferred example embodiments, correction controller 26 is implemented as one or more software components comprising executable software code that is executed on one or more hardware processors in a manner readily known to those skilled in the art. The one or more hardware processors may be commercially available microprocessors from Intel, AMD, Apple, IBM, Fairchild, ARM or others. In some example embodiments, the software components implementing the correction controller 26 may be installed and/or executed on commercially available computer hardware operating one or more of commercially available computer hardware operating systems, such as Windows, Unix, Linux, MacOS. In some example embodiments, the software components implementing the correction controller 26 may be installed and/or executed on one or more virtual machines, such as virtual machines based on Hyper-V, Powershell and/or Kybernetes Clusters. The software components implementing the correction controller 26 may be installed on hardware already present in a conventional manufacturing installation, such as the hardware implementing machine controller 14. By way of example, there are programmable logic controllers (PLCs) acting as machine controllers and implemented on hardware that is similar to hardware of a conventional personal computer running an operating system like Windows or Unix/Linux. The functionality of the correction controller 26 may also be implemented on such a hardware platform. In yet further example embodiments, the software components implementing the functionality of the correction controller 26 may be installed on cloud computers and/or edge computers of a computer network.

Correction controller 26 may include a user interface (not shown here) for allowing user interaction, such as a computer display, a keyboard, a mouse, a trackball etc. In FIG. 1, the example embodiment further comprises a functional module 28 that is called base level comparator in the following and is implemented as a software module that facilitates at least one of the following method steps:
obtaining nominal workpiece data defining desired workpiece characteristics for the workpiece,
obtaining a control program comprising a plurality of control commands and a plurality of nominal numerical control parameters, with the nominal numerical control parameters each determining a nominal kinematic behavior of the moveable machine element during a production run,
obtaining a data set that comprises a plurality of past numerical control parameters used during a plurality of past production runs on manufacturing machine 12 and comprises a plurality of past measurement values recorded on workpieces produced by the plurality of past production runs, wherein the plurality of past numerical control parameters and the plurality of past measurement values form a first plurality of data pairs representing a first temporal sequence of the past production runs; the data set may comprise the first plurality of data pairs arranged in a Hankel matrix having a defined rank,
obtaining a second plurality of data pairs that represent a temporal sequence of recent production runs on manufacturing machine 12, with each data pair of the second plurality of data pairs comprising respective actual numerical control parameters used during a respective one of the recent production runs and respective actual measurement values resulting therefrom,
obtaining a reference sequence of data pairs based on the nominal numerical control parameters and based on nominal measurement values corresponding to the nominal workpiece data,
determining modified numerical control parameters using the reference sequence of data pairs, using the data set comprising the first plurality of data pairs, and using the second plurality of data pairs as a defined starting sequence, wherein the modified numerical control parameters define at least one data pair that extends the defined starting sequence based on the first plurality of data pairs and based on the reference sequence of data pairs, and
transferring the modified numerical control parameters to machine controller 14 for a next production run.

By way of example, a cutting tool may be moved a small amount further into the workpiece during machining compared to what would have been the case if the nominal numerical control parameters were used in order to compensate for increasing wear of the cutting tool over a plurality of production runs.

In the example embodiment shown, correction controller 26 optionally comprises a functional module 30 raw data processor & sensor controller in FIG. 1. Software module 30 operates as a metrology sensor adapter configured to generate formatted point cloud data in a predefined format from raw measurement values obtained by metrology device 24. The formatted point cloud data preferably represent the produced workpiece by a plurality of 3D points relative to a predefined coordinate system in a standardized form, such that various types and brands of metrology devices 24 may be used to communicate with base level comparator 28. Functional modules 28, 30 may exchange data with each other and with machine controller 14 and/or metrology device 24, respectively, as indicated in FIG. 1. Preferably, correction controller 26 further comprises a dedicated machine adapter configured to translate error correction commands into the plurality of modified control commands and parameters for a specific type and brand of machine controller 14 used in the respective manufacturing installation.

With respect to further details and variations of such a manufacturing installation, reference is made to applicants co-pending international patent application PCT/EP2023/068020, filed on 30 Jun. 2023 with the European Patent Office, which co-pending international patent application is incorporated by reference herewith in its entirety. As described above, one or more method steps of the new method may be implemented on the SOMM base level comparator described in more detail in PCT/EP2023/068020. In addition or alternatively, one or more method steps of the new method may be implemented on what is termed SOMM High Level Controller in PCT/EP2023/068020. By way of example, a data set comprising a first plurality of data pairs may be recorded on one manufacturing machine and later obtained on another manufacturing machine via the SOMM High Level Controller.

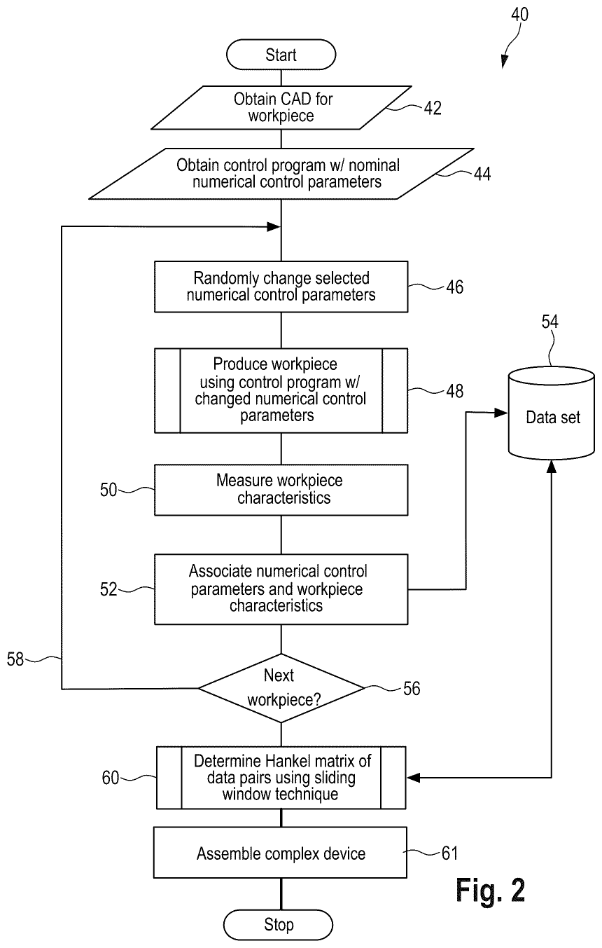

FIG. 2 shows an example embodiment of a method 40 for exploring the behavior of the manufacturing installation 10 during series production of workpieces that are intended to be used for purposes other than exploring the behavior of the manufacturing installation. In other words, method 40 is an example embodiment for recording a production history of manufacturing installation 10 during series production.

According to step 42, nominal workpiece characteristics for the plurality of workpieces (not shown here) are obtained. The nominal workpiece characteristics may be defined in a CAD data file. Based on the nominal workpiece characteristics, and as shown at reference numeral 44, a control program comprising control commands and nominal numerical control parameters is determined in a manner known to those skilled in the art. At step 46, however, one or more nominal numerical control parameters are deliberately and preferably randomly changed in accordance with acceptable tolerances defined by the nominal workpiece characteristics. Preferably, the respective changes are limited such that predefined tolerance thresholds are not exceeded with a high likelihood of preferably more than 97%. This helps to keep the manufacturing installation within its usual operating limits. By way of example, one or more nominal numerical control parameters may randomly be changed within limits of up to 20%, preferably up to 10% with respect to the respective nominal numerical control parameter.

At step 48, a first workpiece is produced using the manufacturing installation 10 and using control program with the modified numerical control parameters. According to step 50, the workpiece is inspected/measured in order to determine actual workpiece characteristics of the workpiece. According to step 52, the modified numerical control parameters and the workpiece characteristics of the calibration workpiece resulting therefrom are associated. In some preferred example embodiments, the actual numerical control parameters used for production and the associated workpiece characteristics form a data pair wₖ=(uₖ, yₖ) comprising an input vector uₖ containing the numerical control parameters used and an output vector yₖ containing the measurement values representing the workpiece characteristics. The data pair wₖ is stored in a data set in a non-transient memory 54 in this example embodiment.

At step 56, it is decided if the next workpiece from the plurality of workpieces is to be produced. If in the affirmative, the method loops back to step 46, as is shown at reference numeral 58 and a second workpiece is produced with another set of preferably randomly modified control parameters in a second production run. If the desired number T of workpieces is produced, the data pairs wₖ are preferably arranged in a sequence according to the temporal order of the workpieces produced, such that a temporal sequence w_{d}=(w₁, w₂, w₃ . . . , w_{T}) of the production runs is established.

According to optional step 60, an optional sliding window technique may be used to split the temporal sequence w_{d}=(w₁, w₂, w₃ . . . , w_{T}) into a plurality of subsequences of length L<T. The subsequences may advantageously be arranged in a Hankel matrix H_{L}(w_{d}) as follows

$${H}_{L} ( {w}_{d} ) = [ \begin{matrix}{w}_{1} & … & {w}_{T - L + 1} \\ ⋮ & ⋱ & ⋮ \\ {w}_{L} & … & {w}_{T}\end{matrix} ]$$

and also stored in data set 54. As a result, data set 54 comprises a plurality of numerical control parameters uₖ used during a plurality of production runs on manufacturing machine 12, and comprises a plurality of past measurement values yₖ recorded on the workpieces produced by the plurality of production runs. The plurality of numerical control parameters and the plurality of measurement values are associated to each other such that a first plurality of data pairs wₖ=(uₖ, yₖ) are formed, with each data pair wₖ comprising actually used numerical control parameters uₖ and measurement values yₖ resulting therefrom. The first plurality of data pairs wₖ thus represent a temporal sequence w_{d} of the production runs.

According to step 61, a complex device may be assembled using one or more of the workpieces produced during the plurality of production runs. Alternatively or additionally, the workpieces produced may be packed for transport or storage and/or shipped to customers or distributors for further use.

In preferred example embodiments, T may advantageously be selected such that the Hankel matrix H_{L}(w_{d}) reaches its maximal theoretical rank which can be proven to be

rank H_{L}(w_{d})=mL+n

with n representing an estimated upper bound of the number of hidden states of the system, i.e. manufacturing installation 10. Any sequence w of data pairs that is part of the image of Hankel matrix H_{L}(w_{d}) is a “valid” sequence that can be achieved with manufacturing installation 10. Verification can be performed by the condition

rank [H_{L}(w_{d})w]=rank H_{L}(w_{d})

In general, it can be said that any valid sequence w represents a trajectory in a parameter space that is spanned by the temporal sequence w_{d}=(w₁, w₂, w₃ . . . , w_{T}) of the plurality of data pairs wₖ. This may advantageously be used in the following to determine modified numerical control parameters for further production runs on manufacturing installation 10.

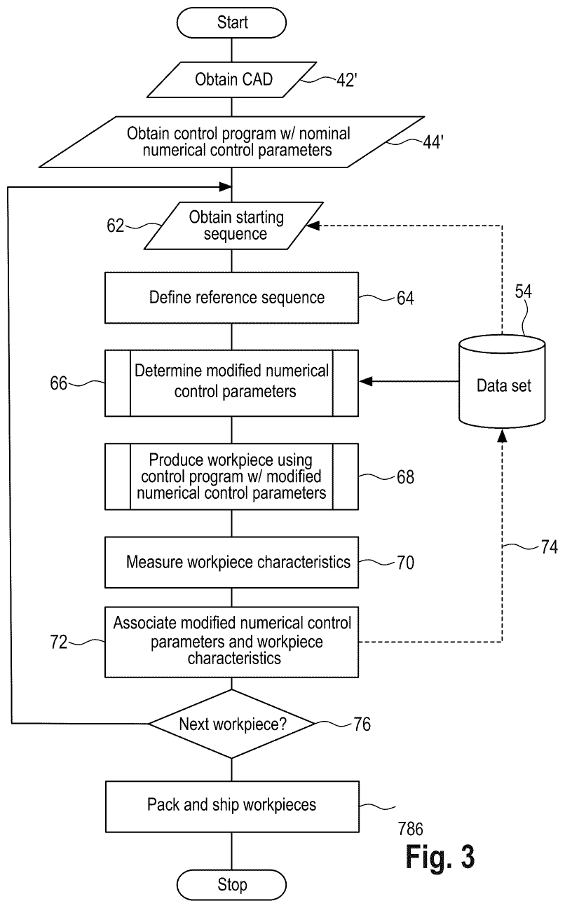

As shown in FIG. 3 at step 42′, the desired workpiece characteristics for a further workpiece can be obtained. As in the method shown in FIG. 2, desired workpiece characteristics may be represented in a CAD data set or in any other data set equivalent thereto. According to step 44′, a control program comprising control commands and nominal numerical control parameters is determined based on the desired workpiece characteristics. Steps 42′ and 44′ correspond to steps 42, 44 in the method shown with reference to FIG. 2.

At step 62, a starting sequence wᵢₙᵢ of data pairs representing more recent production runs on manufacturing installation 10 is obtained. The starting sequence wᵢₙᵢ has a predefined length Tᵢₙᵢ, i.e. it comprises a predefined number Tᵢₙᵢ of data pairs. A prediction horizon T_{f} is selected. The Hankel matrix H_{L}(w_{d}) has a maximal rank for L=Tᵢₙᵢ+T_{f}.

In some example embodiments, one or more data pairs for the starting sequence wᵢₙᵢ may be taken from the plurality of data pairs already stored in data set 54. Therefore, one or more data pairs of starting sequence wᵢₙᵢ may originate from the production runs explained with reference to FIG. 2.

At step 64, a reference sequence wᵣ=(uᵣ, yᵣ) of data pairs is determined from the desired workpiece characteristics and, by way of example, from the nominal numerical control parameters. Alternatively, numerical control parameters already modified for previous production runs may be used, which is particularly advantageous if a series of workpieces of the same type and size is produced in successive production runs. In some example embodiments, reference sequence wᵣ may have a plurality of data pairs (uᵣ, yᵣ) that each are the same. The length of reference sequence wᵣ is preferably chosen to be the same as prediction horizon T_{f}. In any case, reference sequence wᵣ does not need to be a valid trajectory within the parameter space of manufacturing installation 10. Rather, it is a theoretical sequence of set values.

According to step 66, modified numerical control parameters are now determined by searching for a future sequence w_{f}=(u_{f}, y_{f}) of data pairs that minimizes the expression

$${‖ {w}_{f} - {w}_{r} ‖}_{2}^{2} = {\sum }_{k = 1}^{{T}_{f}} {‖ {w}_{f}^{k} - {w}_{r}^{k} ‖}_{2}^{2}$$

and, additionally, is a valid continuation of starting sequence wᵢₙᵢ. The concatenation of sequence wᵢₙᵢ and sequence w_{f} has to form a valid sequence of length L=Tᵢₙᵢ+T_{f}. In this regard, one can say that concatenated sequences wᵢₙᵢ and w_{f} can substantially be derived as a linear combination of the sequences of data set 54. The optimization task can be solved by standard methods and quadratic solvers, such as https://osqp.org.

Preferably, the modified numerical control parameters of the first data pair of the sequence T_{f} are used for the next production run in accordance with step 68. According to step 70, the workpiece produced in step 68 using the modified numerical control parameters is measured to determine its actual workpiece characteristics. According to step 72, the modified numerical control parameters and the actual workpiece characteristics are associated to form a most recent data pair that is advantageously used to update the starting sequence wᵢₙᵢ for the next production run, as it is indicated at reference numeral 74. However, it is conceivable to skip step 70 for a limited number of workpieces in a series production, if production cycle times are considerably shorter than process fluctuations. Accordingly, yet another workpiece may be produced in accordance with step 76.

According to step 78, the workpieces produced may be packed for transport or storage and/or shipped to customers or distributors for further use. Moreover, the workpieces may be used in the assembly of a more complex device, as already mentioned with respect to FIG. 2.

The method according to FIG. 3 is based on the assumption that manufacturing installation 10 is a linear and time-invariant system and that the data is exact, i.e. not subject to noise. In case of unacceptably noisy data, there are several tools which can optionally be applied to overcome the issue. A simple one is to approximate the Hankel matrix using a low rank approximation computed from a singular value decomposition of H_{L}(w_{d}).

Another approach is to leave the Hankel matrix H_{L}(w_{d}) unaltered and to modify the optimization problem instead. These modifications target both noise in the initial data and in the representation data and comprise adding relaxation terms to the objective function and constraint relaxation by introducing penalized slack variables, as is suggested by Ivan Markovsky and Florian Dörfler in the publication “Behavioral systems theory in data-driven analysis, signal processing, and control” mentioned at the outset. Moreover, it has turned out that the method according to FIG. 3 also performs well for non-linear systems. In some example embodiments, the data set 54 may be updated from time to time in order to compensate for time variant behavior or non-linearities.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD or DVD). The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR. The phrase “A, B, and/or C” should be construed in the same way as the phrase “at least one of A, B, and C.”

1. A method of producing a plurality of workpieces in a manufacturing installation including a manufacturing machine having a moveable machine element, a machine controller configured to control the moveable machine element based on a control program, and a metrology device configured to record a plurality of measurement values on a produced workpiece in order to determine respective workpiece characteristics of the produced workpiece, the method comprising:
obtaining nominal workpiece data defining respectively desired workpiece characteristics for the plurality of workpieces and defining acceptable tolerances for the respectively desired workpiece characteristics;
obtaining a control program in association with the nominal workpiece data;
producing the plurality of workpieces using the moveable machine element, the machine controller and the control program in a plurality of individual production runs; and
inspecting the plurality of workpieces using the metrology device to obtain respective actual workpiece characteristics for the plurality of workpieces,
wherein:
the control program includes a plurality of control commands and a plurality of numerical control parameters associated with the nominal workpiece data,
the plurality of numerical control parameters determine a respective kinematic behavior of the moveable machine element during a respective individual production run,
individual numerical control parameters from the plurality of numerical control parameters are deliberately varied from one individual production run to another individual production run,
the respective actual workpiece characteristics are associated with the individual numerical control parameters based on the respective individual production run, thereby establishing a data set representing characteristic machine behavior, and
a set of further workpieces is produced based on the data set.

2. The method of claim 1, wherein the individual numerical control parameters are deliberately varied from one individual production run to another individual production run based on the acceptable tolerances.

3. The method of claim 1, wherein:
the individual numerical control parameters used during the respective individual production run form a set of individual numerical control parameters, and
the individual numerical control parameters are deliberately varied in such a manner that different sets of individual numerical control parameters are used from one individual production run to another individual production run.

4. The method of claim 1, wherein the individual numerical control parameters are systematically varied within predefined variation limits.

5. The method of claim 1, wherein:
each workpiece of the plurality of workpieces has a limited number of workpiece features, and
the individual numerical control parameters are varied with respect to a selected workpiece feature of the limited number of workpiece features at a time.

6. The method of claim 1, further comprising:
obtaining further nominal workpiece data defining desired workpiece characteristics for the set of further workpieces;
obtaining a further control program in association with the further nominal workpiece data; and
producing the set of further workpieces using the moveable machine element, the machine controller and the further control program,
wherein the further control program is obtained based on the further nominal workpiece data and based on the data set representing the characteristic machine behavior.

7. The method of claim 6, wherein the desired workpiece characteristics for the set of further workpieces differ from the desired workpiece characteristics for the plurality of workpieces.

8. The method of claim 6, wherein:
the data set is established to include a plurality of data pairs,
each data pair of the plurality of data pairs includes the individual numerical control parameters used during a respective individual production run from the plurality of individual production runs and includes measurement values representing the respective actual workpiece characteristics resulting therefrom, and
the plurality of data pairs represent a temporal sequence of the plurality of individual production runs.

9. The method of claim 8, wherein:
a reference sequence of data pairs is defined based on nominal numerical control parameters and based on nominal measurement values corresponding to the further nominal workpiece data,
modified numerical control parameters are determined using the reference sequence of data pairs, and
the set of further workpieces is produced using the modified numerical control parameters instead of the nominal numerical control parameters.

10. The method of claim 1, wherein the plurality of workpieces are workpieces of a same type.

11. The method of claim 1, wherein the plurality of workpieces includes workpieces of different types.

12. The method of claim 1, further comprising assembling a complex device using at least one workpiece of the plurality of workpieces.

13. The method of claim 1, further comprising at least one of:
packing the plurality of workpieces for shipment; or
shipping the plurality of workpieces to at least one of a distributor or a number of customers.

14. A manufacturing installation for producing a plurality of workpieces, the manufacturing installation comprising:
a manufacturing machine having a moveable machine element;
a machine controller configured to control the moveable machine element based on a control program; and
a metrology device configured to record a plurality of measurement values on a produced workpiece in order to determine workpiece characteristics of the produced workpiece,
wherein the machine controller includes at least one processor configured to:
obtain nominal workpiece data defining respectively desired workpiece characteristics for the plurality of workpieces and defining acceptable tolerances for the respectively desired workpiece characteristics;
obtain a control program in association with the nominal workpiece data;
produce the plurality of workpieces using the moveable machine element, the machine controller and the control program in a plurality of individual production runs;
inspect the plurality of workpieces using the metrology device in order to obtain respective actual workpiece characteristics for the plurality of workpieces, wherein:
the control program includes a plurality of control commands and a plurality of numerical control parameters associated with the nominal workpiece data, and
the plurality of numerical control parameters determine a respective kinematic behavior of the moveable machine element during a respective individual production run;
deliberately vary individual numerical control parameters from the plurality of numerical control parameters from one individual production run to another individual production run;
associate the respective actual workpiece characteristics with the individual numerical control parameters based on the plurality of individual production runs, thereby establishing a data set representing characteristic machine behavior; and
store the data set in a non-transitory memory.

15. A non-transitory computer-readable medium comprising program code configured to perform, when the program code is executed on at least one processor of a manufacturing installation having a moveable machine element and a metrology device:
obtaining nominal workpiece data defining respectively desired workpiece characteristics for a plurality of workpieces and defining acceptable tolerances for the respectively desired workpiece characteristics;
obtaining a control program in association with the nominal workpiece data;
producing the plurality of workpieces using the moveable machine element in a plurality of individual production runs; and
inspecting the plurality of workpieces using the metrology device in order to obtain respective actual workpiece characteristics for the plurality of workpieces,
wherein:
the control program includes a plurality of control commands and a plurality of numerical control parameters associated with the nominal workpiece data,
the plurality of numerical control parameters determine a respective kinematic behavior of the moveable machine element during a respective individual production run,
individual numerical control parameters of the plurality of numerical control parameters are deliberately varied from one individual production run to another individual production run,
the respective actual workpiece characteristics are associated with the individual numerical control parameters based on the respective individual production runs, thereby establishing a data set representing characteristic machine behavior, and
the data set is stored in the non-transitory computer-readable medium.
